(19) United States
(12) Patent Application Publication
(10) Pub. No.: US 2012/0257293 A1
(43) Pub. Date: Oct. 11, 2012

(54) AUTO-FOCUSING METHOD

(75) Inventor: CHAU-YUAN KE, Tu-Cheng (TW)

(73) Assignee: HON HAI PRECISION INDUSTRY CO., LTD., Tu-Cheng (TW)

(21) Appl. No.: 13/149,945

(22) Filed: Jun. 1, 2011

(30) Foreign Application Priority Data
Apr. 7, 2011 (TW) 100111952

(51) Int. Cl. G02B 7/09

(52) U.S. Cl. 359/824

(57) ABSTRACT

An auto-focusing method includes (1) inputting a current with a predetermined greatest value I₀ to a voice coil motor, such that the voice coil motor drives a lens module to move a greatest distance to a given position; and (2) gradedly decreasing the current inputted to the voice coil motor by decrement of Δ I, such that the voice coil motor progressively drives the lens module to move backward a corresponding distance away from the given position until a focus position is determined.

### BACKGROUND

1. Technical Field

The present disclosure relates to auto-focusing methods, and particularly to an auto-focusing method with a voice coil motor for a lens module.

2. Description of Related Art

Many lens modules use a voice coil motor (VCM) for auto-focusing. The VCM converts an input current to an impelling force for the lens module, and the input current corresponds to a displacement of the lens module. Usually, the input current is gradually increased from zero, and once the input current increases to an initiating current, the VCM begins to drive the lens module to move to a focus position. However, sometimes, due to dust or adhesive stickiness, the VCM cannot initiate at the right moment, i.e., a movable portion of the VCM cannot move immediately when the input current reaches the initiating value, and as the input current further increases, the VCM may move suddenly when it overcomes the impediment to movement. This may result in the lens module being unable to finely focus, as the sudden movements may cover greater distance than the needed adjustment.

What is needed, therefore, is an auto-focusing method, which can overcome the above shortcomings.

### BRIEF DESCRIPTION OF THE DRAWINGS

Many aspects of the present auto-focusing method can be better understood with reference to the following drawings. The components in the drawings are not necessarily drawn to scale, the emphasis instead being placed upon clearly illustrating the principles of the present auto-focusing method. Moreover, in the drawings, like reference numerals designate corresponding parts throughout the several views.

FIG. 1 is a graph showing a relationship between a displacement S in a lens module using a VCM to auto-focus and an input current I for the VCM, and a relationship between an image sharpness evaluation function F(n) and the input current I.

FIG. 2 is a flow chart of an auto-focusing method in accordance with one embodiment.

### DETAILED DESCRIPTION

Embodiments of the present auto-focusing method will now be described in detail below and with reference to the drawings.

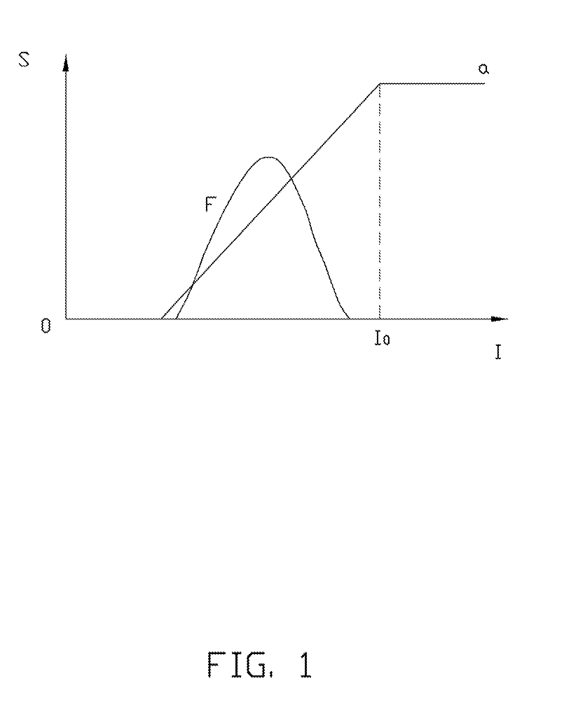

FIG. 1 shows a relationship between a displacement S in a lens module using a VCM to auto-focus and an input current I for the VCM, and a relationship between an image sharpness evaluation function F(n) and the input current I.

The line a represents the relationship between the displacement S of the lens module and an input current I. From this line a, it can be concluded that the displacement S of the lens module increases as the input current I of the VCM increases until the input current I is increased to a predetermined greatest value I₀.

Each input current I(n) corresponds to an image sharpness value of the image sharpness evaluation function F(n), where n is an integer. The image sharpness evaluation function F(n) is similar to a parabola opening downwards, which has a best image sharpness at the top point. The camera may have calculating software for calculating such image sharpness values.

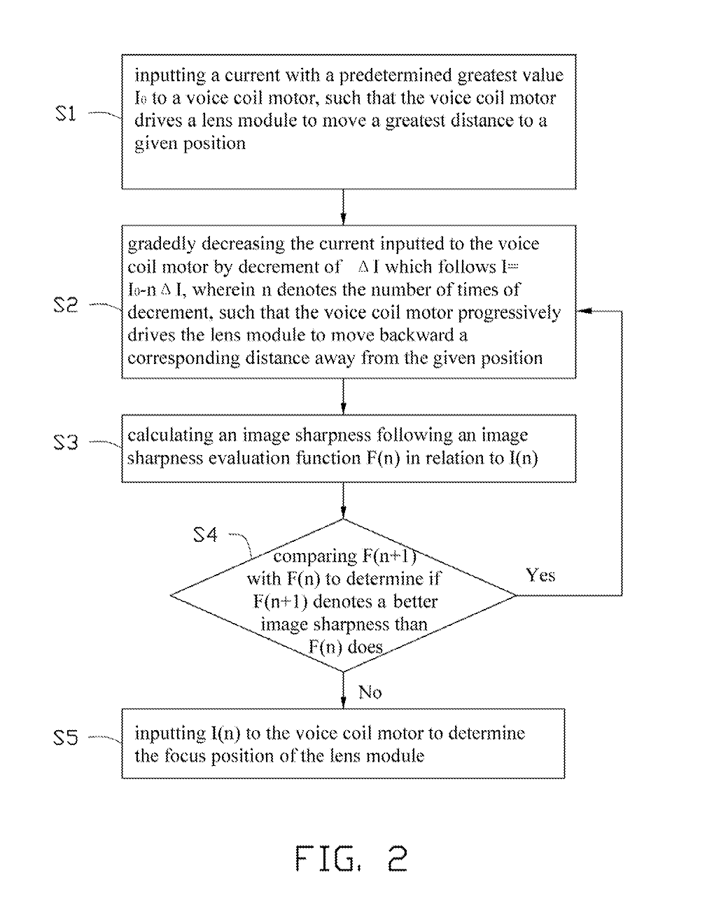

Based on the above characteristic of the displacement S of the lens module and the image sharpness evaluation function F(n), an auto-focusing method in the present embodiment has the following steps shown in FIG. 2.

In step S1, a current with a predetermined greatest value I₀ is input to the VCM. With this greatest current I₀, the VCM will drive the lens module directly to a given position with the greatest displacement S.

In step S2, the current inputted to the voice coil motor is gradedly decreased by decrement of Δ I which follows In=I₀−nΔ I, wherein Δ I is a fixed positive number, and n denotes the number of times of decrement beginning from one. That is, the input current in a following step is decreased one times the value of Δ I relative to the previous step. With this input current, the VCM will drive back the lens module a predetermined distance away from the previous displacement.

In step S3, per backward movement of the lens module, a corresponding value of the image sharpness evaluation function F(n) in relation to I(n) is calculated.

In step S4, F(n+1) is compared with F(n). If F(n+1) denotes a better image sharpness than F(n) does, a current I=I(n+2)=I₀−(n+2)Δ I is input to the VCM, and then a corresponding value of the image sharpness evaluation function F(n+2) can be obtained, until that F(n+k) denotes a worse image sharpness than F(n+k−1) does is found. Wherein k is a positive integer.

If F(n+1) denotes a worse image sharpness than F(n) does, or F(n+k) denotes a worse image sharpness than F(n+k−1) does, it goes to step S5, the current is turned back to the respective I(n) or I(n+k−1), and the focusing position of the lens module is found with the input current for VCM being the corresponding I(n) or I(n+k−1).

An acceptable input current I for VCM is usually in a range from 0 to 80 mA, and the VCM can reach a greatest displacement S with an input current between 60 mA to 70 mA. The greatest current I₀ of the present embodiment can be the current 70 mA corresponding to the greatest displacement S. In other embodiments, the greatest current I₀ is in a range of 100%-105% of the current inputted to the voice coil motor to achieve a nearest focus position, where the lens module is farthest from the give position with the greatest displacement S.

In accordance with the present embodiment, the lens module is first directly driven to the greatest displacement, then is driven back as the input current is decreased to find a focus position. In this way, even if it is hard to get the VCM started, precise focusing can be accomplished.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An auto-focusing method, the method comprising:
(1) inputting a current with a predetermined greatest value I₀ to a voice coil motor, such that the voice coil motor drives a lens module to move a greatest distance to a given position; and
(2) gradedly decreasing the current inputted to the voice coil motor by decrement of Δ I, such that the voice coil motor progressively drives the lens module to move backward a corresponding distance away from the given position until a focus position is determined.

2. The method of claim 1, wherein in step (2), the current I inputted to the voice coil motor follows a formulation I=I(n)=I₀−nΔ I, wherein Δ I is a fixed positive number, and n denotes the number of times of decrement.

3. The method of claim 2, wherein in step (2), the image sharpness is calculated upon per backward movement of the lens module.

4. The method of claim 3, further comprising determining if the focus position is reached by evaluating if the calculated image sharpness is acceptable upon per backward movement of the lens module.

5. The method of claim 1, wherein the greatest value I₀ is in a range from 100% to 105% of the current inputted to the voice coil motor to achieve a focus position where the lens module is farthest from the give position.
